(19) United States
(12) Patent Application Publication
(10) Pub. No.: US 2003/0065697 A1
(43) Pub. Date: Apr. 3, 2003

(54) Fast, iterative system and method for evaluating a modulo operation without using division

(76) Inventors: Shimman Patel, San Diego, CA (US); Andrew Kan, San Diego, CA (US); Rajat Dhawan, San Diego, CA (US)

Correspondence Address: Sarah Kirkpatrick, Manager, Intellectual Property Administration, QUALCOMM Incorporated, 5775 Morehouse Drive, San Diego, CA, 92121-1714, US

(21) Appl. No.: 09/981,130

(22) Filed: Oct. 17, 2001

Related U.S. Application Data
(60) Provisional application No. 60/316,135, filed on Aug. 29, 2001.

(51) Int. Cl. G06F 7/38

(52) U.S. Cl. 708/491

(57) ABSTRACT

A fast, iterative techique for evaluating M modulo J which may be easily implemented in hardware. In the illustrative embodiment, the invention includes a first circuit (10) for decomposing M into two integers A and B=M−A; a second circuit (20) for evaluating (A modulo J); a third circuit (30) for evaluating M′=(A modulo J)+B; and, a fourth circuit (40) for determining whether to output M′ as the final answer, or to feedback M′ to said first means to evaluate M′ modulo J.

### BACKGROUND OF THE INVENTION

This application claims the benefit of provisional U.S. Application Serial No. 60/316,135, entitled “FAST, ITERATIVE SYSTEM AND METHOD FOR EVALUATING A MODULO OPERATION WITHOUT USING DIVISION,” filed Aug. 29, 2001, which is incorporated herein by reference in its entirety for all purposes.

1. Field of the Invention

The present invention relates to electronic circuits and systems. More specifically, the present invention relates to hardware implementation of arithmetic operators for use in communications systems.

2. Description of the Related Art

Interleaving of coded data for transmission (in combination with deinterleaving at the receiver) has been an effective method of transforming burst errors into statistically independent errors. Interleaving reorders the coded data sequence in an apparently random order, such that after the data is returned to its proper sequence by the deinterleaver, error bursts are spread out in time. Thus errors within one code word appear to be independent.

Previous transmission standards used a method of interleaving involving bit reversal of parts of the binary representation of bin numbers to randomize the data sequence. However, a new wireless standard, CDMA2000, requires a deinterleaver which uses a modulo operation. In particular, it requires the evaluation of M modulo J for 0<M<2^{N} and J=3, 6, 12, 24, 48, and 96. The operation M modulo J returns the remainder of M divided by J. Currently, there is no hardware design which implements this modulo operation.

Hence, a need exists in the art for a fast system and method for evaluating M modulo J which can be easily implemented in hardware.

### SUMMARY OF THE INVENTION

The need in the art is addressed by a technique which provides a fast, iterative method for evaluating M modulo J (M mod J) which can be easily implemented in hardware for use in such applications as deinterleavers in communications systems.

In an illustrative implementation, the invention includes the steps of: 1) decomposing M into two integers A and B=M−A; 2) evaluating C=A modulo J; 3) evaluating M′=C+B; and 4) determining whether to output M′ as the final answer, or to feedback M′to said first means to evaluate M′modulo J.

The method may be easily implemented in hardware where for example in Step 1, the integer A is a power of 2 and, in Step 2, A modulo J is stored in a small look-up table for A=2⁰, 2¹, 2² . . . 2^{N}.

### BRIEF DESCRIPTION OF THE DRAWINGS

FIG. 1 is a block diagram of a typical wireless communications system.

FIG. 2 is a block diagram of a typical bit-reversal order deinterleaver.

FIG. 3 is a flow diagram of an iterative algorithm for evaluating M modulo J in accordance with the teachings of the present invention.

FIG. 4 is a block diagram of a hardware implementation for evaluating M modulo J in accordance with the teachings of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herien will recognize additional modifications, applications, and embodiments within the scope thereof and additional fields in which the present invention would be of significant utility.

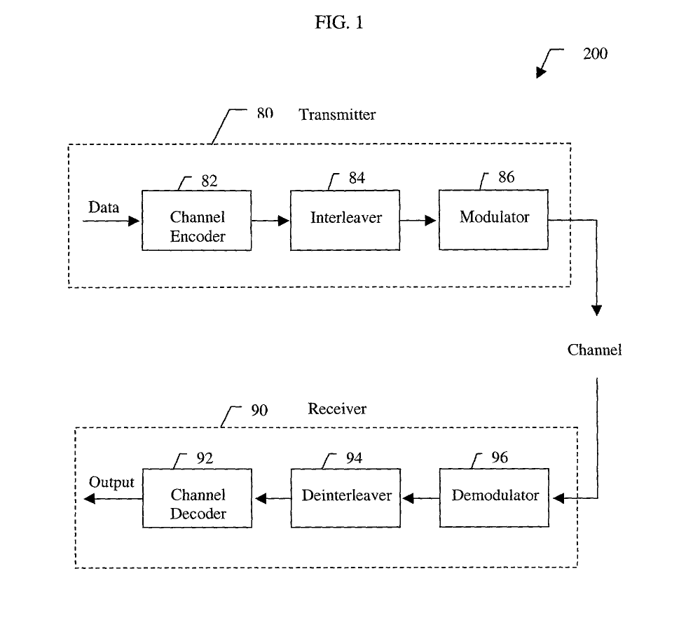

FIG. 1 is a block diagram of a typical communications system 200 using a deinterleaver. The cdma2000 transmission standard calls for an interleaver and a deinterleaver which evaluate M modulo J for 0<M<2^{N} and J=3, 6, 12, 24, 48, and 96. The operation M modulo J (M mod J) returns the remainder of M divided by J.

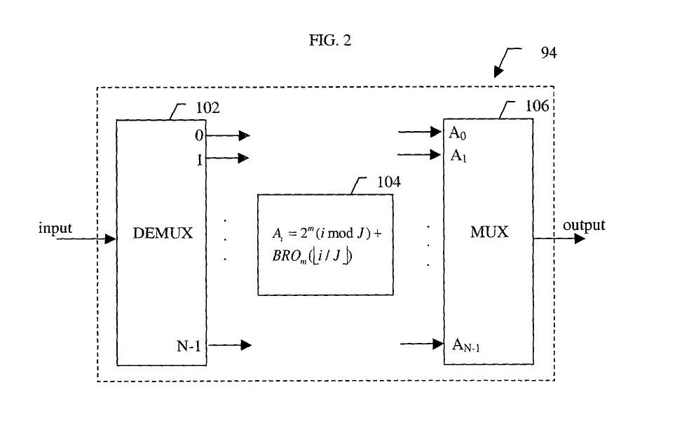

FIG. 2 is a block diagram of a typical bit-reversal order deinterleaver 94. The deinterleaver includes a demultiplexer 102, a multiplexer 106, and a circuit 104 for evaluating Aᵢ=2^{m}(i mod J)+BROₘ(└i/J┘), where └x┘ indicates the largest integer less than or equal to x, BROₘ(y) indicates the bit-reversed m-bit value of y (for example, BRO₃(6)=3), and m and J are given in the following table for a deinterleaver of size N:

| Interleaver Size | m | J |
|---|---|---|
| 48 | 4 | 3 |
| 96 | 5 | 3 |
| 192 | 6 | 3 |
| 384 | 6 | 6 |
| 768 | 6 | 12 |
| 1,536 | 6 | 24 |
| 3,072 | 6 | 18 |
| 6,144 | 7 | 48 |
| 12,288 | 7 | 96 |
| 144 | 4 | 9 |
| 288 | 5 | 9 |
| 576 | 5 | 18 |
| 1,152 | 6 | 18 |
| 2,304 | 6 | 36 |
| 4,608 | 7 | 36 |
| 9,216 | 7 | 72 |
| 18,432 | 8 | 72 |
| 36,864 | 8 | 144 |
| 128 | 7 | 1 |

The symbols input to the deinterleaver 94 are written sequentially at addresses 0 to N−1 in the demultiplexer 102. At the output of the deinterleaver, the symbols are read out in permuted order from address Aᵢ, for i=0 to N−1. The circuit 104 evaluates Aᵢ, and the multiplexer 106 combine the symbols sequentially from A₀ to A_{N-1}.

In computing Aᵢ, the circuit 104 needs to evaluate M modulo J for M=2^{m}i for i=0 to N−1, and m and J given by the above table. Ideally, the M modulo J operation should be implemented in hardware.

The present invention provides a fast, iterative method for evaluating M modulo J (M mod J) which can be easily implemented in hardware for use in applications such as the deinterleaver described above.

A recursive formula for computing M modulo J can be derived from the following algebraic manipulations:

Let M be an integer from 0 to 2^{N}. M can be expressed as a sum of two other integers:

M=A+B. (1)

For any integer J, there exists unique integers qₐ, q_{b}, rₐ, and r_{b} such that:

A=qₐJ+rₐ,

and

B=q_{b}J+r_{b}, (2)

where J>rₐ, r_{b}>0.

Therefore,

A+B=(qₐ+q_{b})J+(rₐ+r_{b}) (3)

It follows that:

M modulo J=(A+B) modulo J=[(qₐ+q_{b})J+(rₐ+r_{b})] modulo J=(qₐ+q_{b})J modulo J+(rₐ+r_{b}) modulo J=(rₐ+r_{b}) modulo J, (4)

since (qₐ+q_{b})J is an integer multiple of J, and therefore has a remainder of 0 when divided by J. Thus (qₐ+q_{b})J modulo J is equal to 0. By similar reasoning, adding a term which is an integer multiple of J will not affect the modulo J operation:

(rₐ+r_{b}) modulo J=(rₐ+q_{b}J+r_{b}) modulo J=[(A modulo J)+B] modulo J, (5)

since A modulo J=(qₐJ+rₐ) modulo J=rₐ.

Therefore:

M modulo J=M′ modulo J, (6)

where M′=A modulo J+B. This leads to an iterative algorithm for evaluating M modulo J.

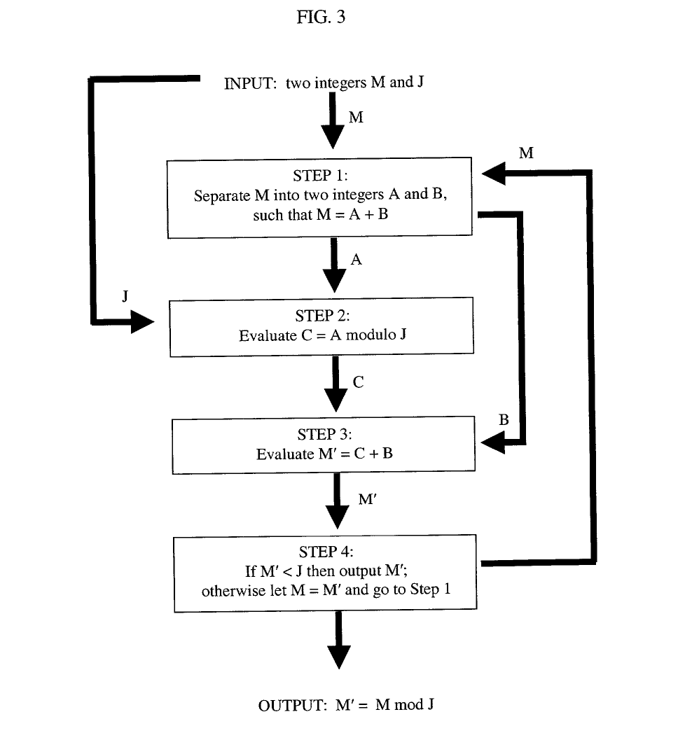

FIG. 3 is a flow diagram of an iterative algorithm for evaluating M modulo J in accordance with the teachings of the present invention. This method includes the following steps:

decomposing M into two integers A and B=M−A;

evaluating C=A modulo J;

evaluating M′=C+B; and,

determining whether to output M′ as the final answer, or to repeat with M=M′ to evaluate M′ modulo J.

This method can be readily implemented in hardware if in Step 1, the integer A is a power of 2, and in Step 2, A modulo J is stored in a look-up table for A=2⁰, 2¹, 2² . . . 2^{N}. Let M be an integer in binary representation, that is, M=Σαᵢ2ⁱ for i=0 to N, and αⁱ=0 or 1. In step 1, A is chosen to be αᵢ2ⁱ. Since αᵢ is either 0 or 1, A is either 0 or 2ⁱ. Thus in Step 2, A modulo J is 0 for αᵢ=0, or 2¹ modulo J for α₁=1. Then, 2ⁱ modulo J can be evaluated through a small look-up table storing 2ⁱ modulo J for i=0 to N, and the values of J required (for this particular application, J=3, 6, 12, 24, 48, or 96). The algorithm is repeated recursively, starting with i=N, and reducing i by 1 with each iteration, until a final answer is reached when M′<J.

In one case, the algorithm does not converge. An additional step between Step 3 and Step 4 is required to insure convergence to the correct answer:

Step 3.5: if the bitwise AND between M′ and J equals J, then let M=M′−J and return to Step 1, otherwise output M′ as the final answer.

The following is a numerical example to further illustrate this method:

### EXAMPLE

Find M modulo J for M=27, J=6.

M=1101_{bin}=2⁴+2³+2¹+2⁰

Let A=α₄2⁴=1000_{bin}=16, and B=M−A=1011_{bin}=11

From a look-up table, find C=A modulo J=16 modulo 6=4

Form M′=C+B=4+11=15=1111_{bin}

Step 3.5: Check if (M′&&J=J): 1111_{bin} && 110_{bin}=110_{bin}=J, therefore let M′=M′−J=15−6=9

Step 4: Check if (M′<J): 9>6, therefore let M=M′=9

and repeat

Step 1: M=9=1001_{bin}

Let A=1000_{bin}=8, and B=M−A=1

Step 2: From a look-up table, find C=A modulo J=8 modulo 6=2

Step 3: Form M′=C+B=2+1=3=11_{bin}

Step 3.5: Check if (M′&&J=J): 11_{bin} && 110_{bin}=10_{bin}≠J, therefore continue to Step 4

Step 4: Check if (M′<J): 3<6, therefore stop. The final answer is 3.

Therefore, 27 modulo 6=3.

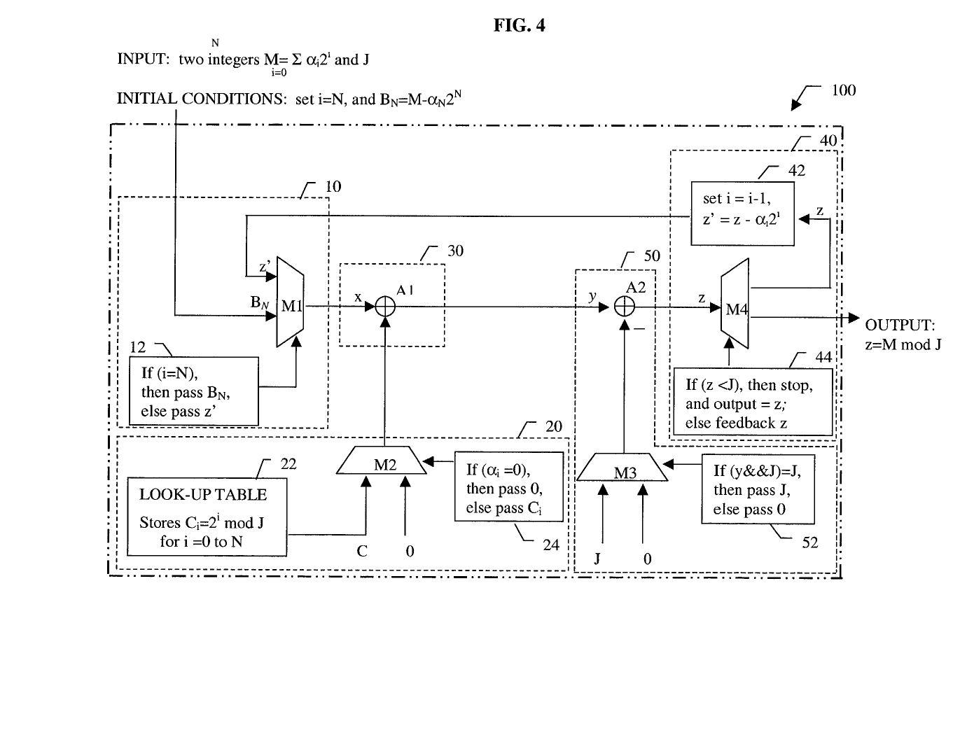

FIG. 4 is a block diagram of an illustrative hardware implementation for evaluating M modulo J in accordance with the teachings of the present invention. The architecture includes a first circuit 10 for decomposing M into two integers A and B=M−A (STEP 1); a second circuit 20 for evaluating A modulo J (STEP 2); a third circuit 30 for evaluating M′=(A modulo J)+B (STEP 3); a fourth circuit 40 for determining whether to output M′ as the final answer, or to feedback M′ to the first circuit 10 to evaluate M′ modulo J (STEP 4); and, a fifth circuit 50 for ensuring convergence (STEP 3.5).

The inputs to this circuit are two integers M and J. Initial conditions are set such that i=N, and B_{N}=M−α_{N}2^{N}.

The first circuit 10 includes a multiplexer M1 which passes B_{N}=(M−α_{N}2^{N}) on the first iteration, and passes Bᵢ=(M′−α₁2¹) on all subsequent iterations, where i is an iteration counter starting with N and counting down. The output of the multiplexer M1 (equivalent to B in the derivations) is passed to the third circuit 30.

The second circuit 20 includes a look-up table 22 which stores 2¹ modulo J for i=0 to N. The second circuit 20 further includes a multiplexer M2 which passes 0 if (α₁=0), and passes Cᵢ if (αᵢ=1). The output of M2 is therefore equivalent to A modulo J, where A=α₁2¹. This output is passed to the third circuit 30.

The third circuit 30 includes an adder A1 which adds the outputs of the first and second circuits and passes the result M′=(A modulo J)+B to the fifth circuit 50.

The fifth circuit 50 includes a multiplexer M3 which passes J if the bitwise AND of M′ and J equals J, otherwise it passes 0. The output of M3 is subtracted from M′ by an adder A2, and the result is passed to the fourth circuit 40.

The fourth circuit 40 includes a multiplexer M4 which passes M′ as the final output if (M′<J); otherwise i is set to i−1, and M′ is fed back to the first circuit 10. The feedback loop is repeated until the condition M′<J is met. Then M′ is output as the final solution to M modulo J.

Hence, the new hardware implementation of FIG. 3 evaluates the operation M modulo J.

Thus, the present invention has been described herein with reference to a particular embodiment for a particular application. Those having ordinary skill in the art and access to the present teachings will recognize additional modifications, applications and embodiments within the scope thereof. For example, those skilled in the art will appreciate that for the algorithm can be used in applications other than a deinterleaver in a communications system. Further, the invention can be used in any digital signal processing (DSP) application requiring the operation M modulo J.

It is therefore intended by the appended claims to cover any and all such applications, modifications and embodiments within the scope of the present invention.

Accordingly,

What is claimed is:

1. A system for evaluating M modulo J, where J is an integer and M is an integer expressed in binary form
$$( M = {\sum }_{i = 0}^{N} {α}_{i} {2}^{i} ) ,$$
where αᵢ is 0 or 1, and N+1 is the number of digits in a binary word) comprising:
a first circuit for decomposing M into two integers A and B=M−A;
a second circuit for evaluating (A modulo J);
a third circuit for evaluating M′=(A modulo J)+B; and
a fourth circuit for outputting M′ or feeding M′ back to the first means to evaluate M′ modulo J.

2. The system of claim 1, wherein the first circuit includes a multiplexer M1 which passes B_{N}=(M−α_{N}2^{N}) to the second circuit on a first iteration, and passes Bᵢ=(M′−αᵢ2¹) on all subsequent iterations, where i is an iteration counter starting with N and counting down.

3. The system of claim 1, wherein the second circuit includes a look-up table that stores C₁=2¹ modulo J for i=0 to N.

4. The system of claim 3, wherein the second circuit further includes a multiplexer M2 that passes 0 to the third circuit when (αᵢ=0), and passes Cᵢ when (αᵢ=1).

5. The system of claim 1, wherein the third circuit includes an adder A1 whose inputs are B₁ and (α₁C₁) and which passes its output M′=Bᵢ+(αᵢCᵢ) to the fourth circuit.

6. The system of claim 1, wherein the fourth circuit includes a multiplexer M4 that passes M′ as a final output if (M′<J); otherwise i is set to i−1, and M′ is fed back to the first circuit.

7. The system of claim 1, wherein the circuit further includes fifth circuit for ensuring convergence.

8. The system of claim 7, wherein the fifth circuit includes a multiplexer M3 that passes J when the bitwise AND of M′ and J equals J, otherwise it passes 0.

9. The system of claim 8, wherein the output of the multiplexer M3 is subtracted from M′ by an adder A2 and the result is passed to the fourth circuit.

10. A deinterleaver comprising:
a demultiplexer;
a multiplexer; and
a circuit for connecting the outputs of the demultiplexer to the inputs of the multiplexer, wherein the circuit includes a system for evaluating M modulo J comprising:
a first circuit for decomposing M into two integers A and B=M−A;
a second circuit for evaluating (A modulo J);
a third circuit for evaluating M′=(A modulo J)+B; and
a fourth circuit for outputting M′ or feeding M′ back to the first circuit to evaluate M′ modulo J.

11. A method for evaluating M modulo J including the steps of:
decomposing M into two integers A and B=M−A;
evaluating (A modulo J);
evaluating M′=(A modulo J)+B; and,
determining whether to output M′ as the final answer, or to feedback M′ to the decomposing step to evaluate M′ modulo J.

12. The method of claim 11, wherein the decomposing involves passing B_{N}=(M−α_{N}2^{N}) to the evaluating (A modulo J) step on a first iteration, and passing B₁=(M′−α₁2ᵢ) on all subsequent iterations, where i is an iteration counter starting with N and counting down.

13. The method of claim 11, wherein evaluating (A modulo J) involves using a look-up table that stores C₁=2ⁱ modulo J for i=0 to N.

14. The method of claim 13, wherein the evaluating (A modulo J) further includes passing 0 to the evaluating M′=(A modulo J)+B step when (α₁=0), and passes C₁ when (αᵢ=1).

15. The method of claim 11, wherein the evaluating M′=(A modulo J)+B step involves using an adder A1 whose inputs are B₁ and (α₁C₁) and which passes its output M′=B₁+(α₁C₁) to the determining step.

16. The method of claim 11, wherein the determining involves passing M′ as a final output when (M′<J); otherwise i is set to i−1, and M′ is fed back to the decomposing step.

17. The method of claim 12, further comprising ensuring convergence has occurred.

18. The method of claim 17, wherein ensuring convergence includes passes J when the bitwise AND of M′ and 3 equals J, otherwise passing 0.
